(19) United States
(12) Patent Application Publication
(10) Pub. No.: US 2004/0128234 A1
(43) Pub. Date: Jul. 1, 2004

(54) Method of conducting financial transactions over the internet

(76) Inventor: Patrick Rioux, St-Nicephore (CA)

Correspondence Address: Baker & Hostetler, Washington Square, Suite 1100, 1050 Connecticut Avenue NW, Washington, DC, 20036, US

(21) Appl. No.: 10/275,401

(22) PCT Filed: May 3, 2001
(86) PCT No.: PCT/IB01/00761

(51) Int. Cl. G06F 17/60

(52) U.S. Cl. 705/39

(57) ABSTRACT

The present invention relates to e-commerce and more particularly, relates to a method and system for payment when shopping on the web without using a credit card.

The present invention relates to e-commerce and more particularly, relates to a method and system for payment when shopping on the web without using a credit card.

The use of the world wide web (the web) for shopping has been increasing at an exponential rate and is forecast to continue this growth for a number of years. Typically, the consumer will look for the wares or goods which they wish to purchase and then either directly, or through an agent, visit the web site of the seller. The purchases can typically be completed by clicking on the items desired, paying for the goods by providing credit card information following which the goods are shipped to the consumer.

A problem associated with shopping on the web is that a valid credit card must be available to the consumer. In many instances, this is not possible either due to the age of the consumer and/or a poor credit rating. Thus, there is a large potential group of consumers which are not able to buy over the web even if they have the money to do so. The alternative is that the consumer must send in a cheque or money order and then wait for the cheque or money order to clear and then receive the goods. This is a long and time consuming process not presenting any advantages over the old economy mail order business.

Even when the consumer does have a credit card, there is a great deal of concern over giving this information via the web. The element of fraud is ever present and many potential purchasers will not provide this information via the web.

Increasingly, certain consumers use bank cards and banking by the web in order to process financial transactions. This now opens up a second method of payment for purchasing a service or product over the Internet.

It is an object of the present invention to provide a method for conducting a financial transaction over the Internet between a purchaser and a seller.

It is a further object of the present invention to provide a method for utilizing a debit card for payment of a financial transaction over the Internet between a purchaser and a seller.

According to one aspect of the present invention, there is provided a method for conducting a financial transaction over the Internet between a purchaser and a seller comprising the steps of receiving a request to purchase a good or service from a customer, supplying the customer with an identifier, linking a customer with a financial institution for authorizing payment for the good or service, and making payment from the financial institution for the good or service.

According to one aspect and embodiment of the present invention, when a consumer wishes to purchase a product or service over the web, the purchaser will initially visit the web site from where the purchase is to be made. In the instance where the consumer is a first time purchaser at the given site, and either following the selection of the merchandise (or prior thereto if so desired), the consumer would be directed to a web page wherein the consumer would be asked to fill in the usual information required for their purchase—i.e. the customer name, address, phone number and e-mail address. This information would then be transmitted to the web site operator who would then assign a customer number to the purchaser. This customer number could either be forwarded to the purchaser by instant e-mail or alternatively, the customer number could be given this information over a web page.

The customer number itself would include a suitable algorithm such that any errors in miskeying a number would be evident. The use of such algorithms is well known in the art.

At this point in time, the new customer or any customer already having a customer number would be directed to a web site of the financial institution with which he or she has an account. This may conveniently be arranged through a pop up menu or by other known methods.

At the web site of the financial institution, the purchaser would add the name of the seller to the list of accounts which could be paid over the Internet. This arrangement is known in the art for those doing banking over the Internet. At the site of the financial institution, the purchaser is typically required to log in using an account name along with a password. Once this has been done, the customer will then complete the necessary steps to pay the bill from the seller using the client number and the amount to be paid. Typically, though not necessarily so, a confirmation number would be provided by the bank or financial institution.

Once the above has been completed, the purchaser would then provide the information to the seller that the transaction has been processed and, if appropriate, provide the confirmation number. Subsequently, the financial institution would credit the account of the seller, this normally being done within a 24 hour period. The seller would then complete the transaction by shipping the goods purchased to the consumer.

Under this method, any purchaser having the necessary funds in a financial institution's account and which can be accessed electronically would have the capability of purchasing over the web. The security of the transaction is assured as the only financial information supplied is between the financial institution and the purchaser, which is done in all banking operations and which is done by a secure web site.

An advantage of the above is that it overcomes the security risk of supplying the financial information to the merchant over lines which may not be secure. There has been shown to be natural reticence on the part of many consumers to provide such information, including credit card numbers, to merchants.

In the instance wherein the purchaser does not have an established account with a financial institution for doing banking over the Internet, an intermediary may be employed. This could also be utilized even when the purchaser does have capability of doing banking over the Internet.

Thus, as will be appreciated, many large firms will have relationships with a multitude of banks and thus there is not a problem for completing the transaction. However, in the instance of a smaller merchant, this capability may not exist. Rather than registering with different institutions, the merchant may choose to register with an intermediary or central clearing. The central clearing would in turn have established relationships with a number of financial institutions and the transaction could proceed on this basis.

In a typical process, the purchaser would go to the seller's web site and select the merchandise or service to be purchased. When it is time to pay, the merchant would provide the necessary identification information along with an identifier. The identifier can be any suitable and would normally include a plurality of numbers and/or letters. Normally, the merchant would provide a reference number, amount to be paid, a merchant identity code and as well a choice of financial means to settle the invoice.

Then, the customer selects a financial institution, there would be an on-line hyperlink (or alternatively e-mail can be used) which will let the customer go to the financial institution and pay the invoice as set forth above. The customer would then provide to the financial institution the information from the merchant's web site—i.e. reference number, the outstanding amount and the name or identification of the merchant. Naturally, it will be understood that such information could be sent directly in the hyperlink as parameters.

After approval from the financial institution, confirmation can be provided to the merchant to permit the finalization of the purchase.

Having thus described the invention, reference will be made to the accompanying drawings thereof, in which:

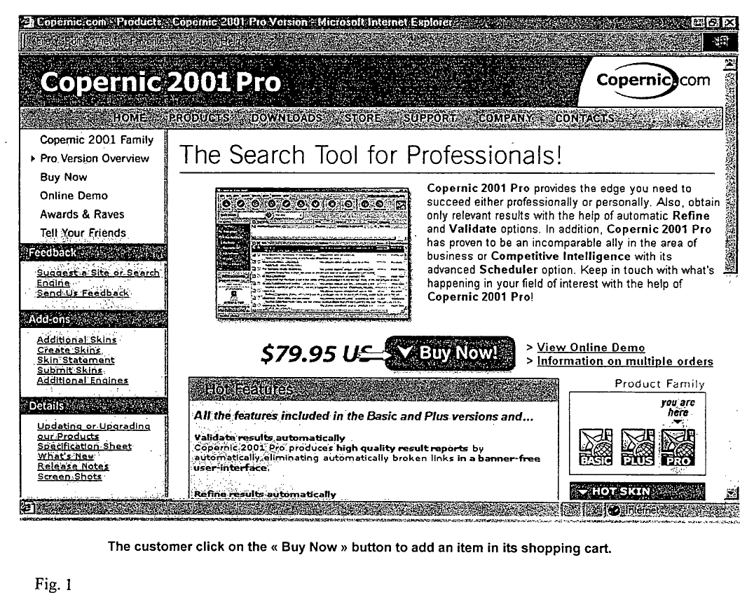

FIG. 1 is a view of a web page offering a product for sale from a merchant;

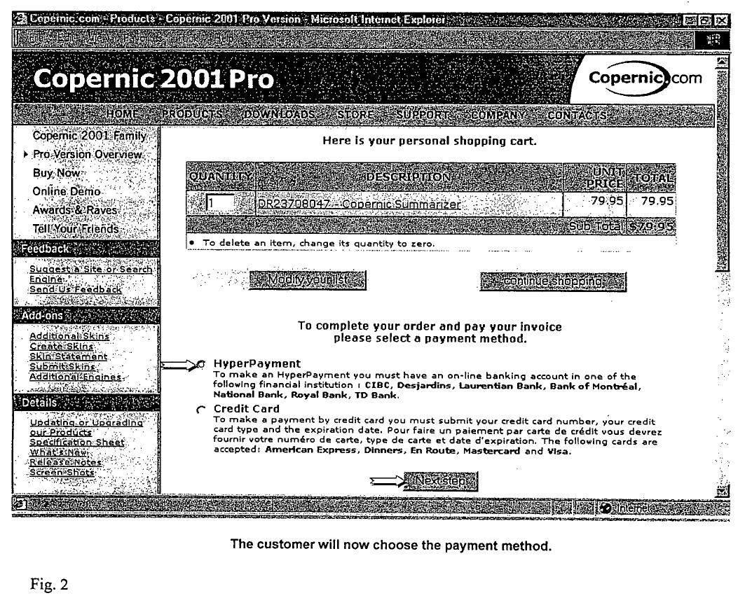

FIG. 2 is a view of a typical web page of the merchant once a product has been selected;

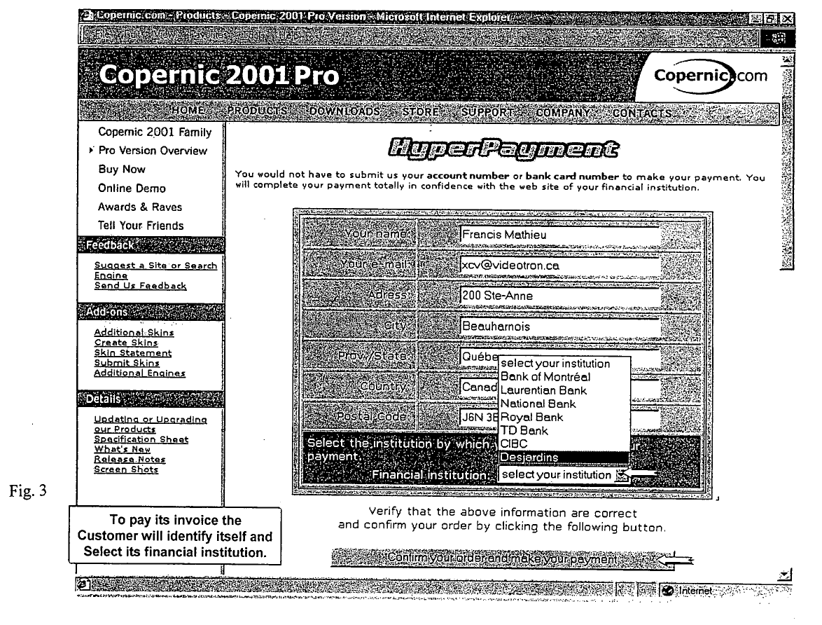

FIG. 3 is a view of a web page of the merchant showing typical information required;

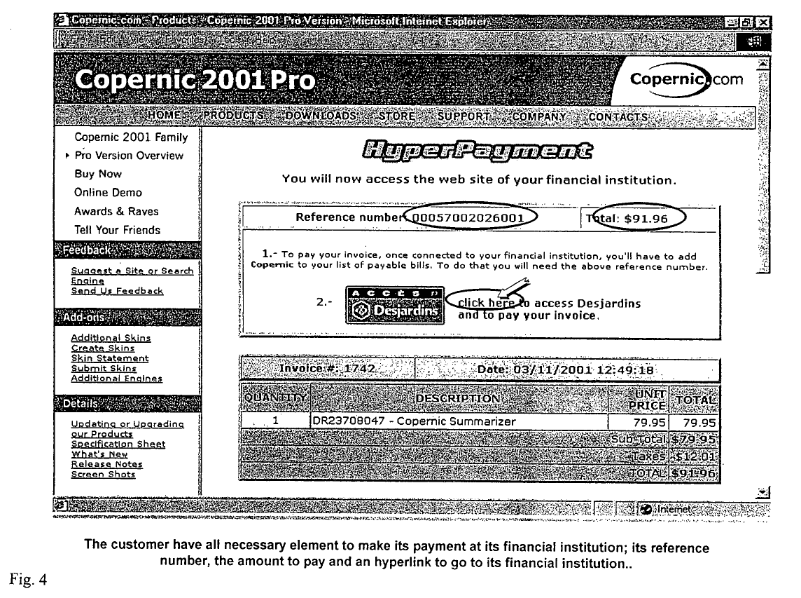

FIG. 4 is a view of a typical web page of the merchant showing a summary of the financial details of the transaction;

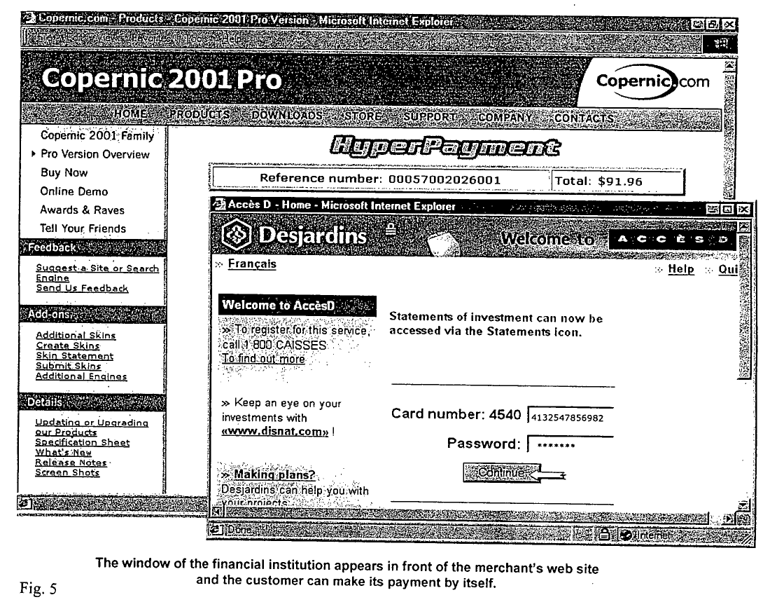

FIG. 5 is a view of the merchant's web page and the web page of a financial institution which has been accessed by hyperlink; and

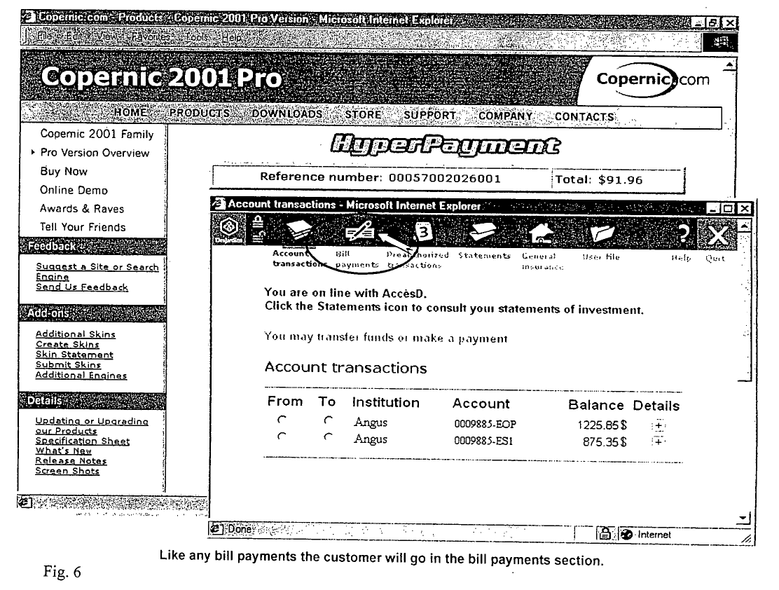

FIGS. 6 to 14 illustrate typical web pages for completion of the financial transaction.

Referring to the drawings in greater detail, FIG. 1 is a web page of a merchant offering a product for sale. As is customary in many such pages, one has a choice of different infra information which may be accessed to provide description of the product being advertised.

In FIG. 2, the web page illustrates the product which the purchase has selected and provides given options—i.e. by credit card as is well known in the art, and an option for direct payment from a financial institution.

FIG. 3 illustrates a subsequent web page in which the purchaser would provide the necessary information such the product can be shipped and also, by means of a pull down menu, provides a selection of different financial institutions which may be accessed by hyperlink.

As shown in FIG. 4, number or identifier is provided along with the financial details of the transaction. There is also provided a hyperlink to the financial institution chosen on a previous screen.

As seen in FIG. 5, a typical window of the financial institution is open and wherein the purchaser can access the financial account by means of name and password.

FIG. 6 illustrates a typical subsequent page of the financial institution wherein one has a choice of various menus including one for the payment of bills.

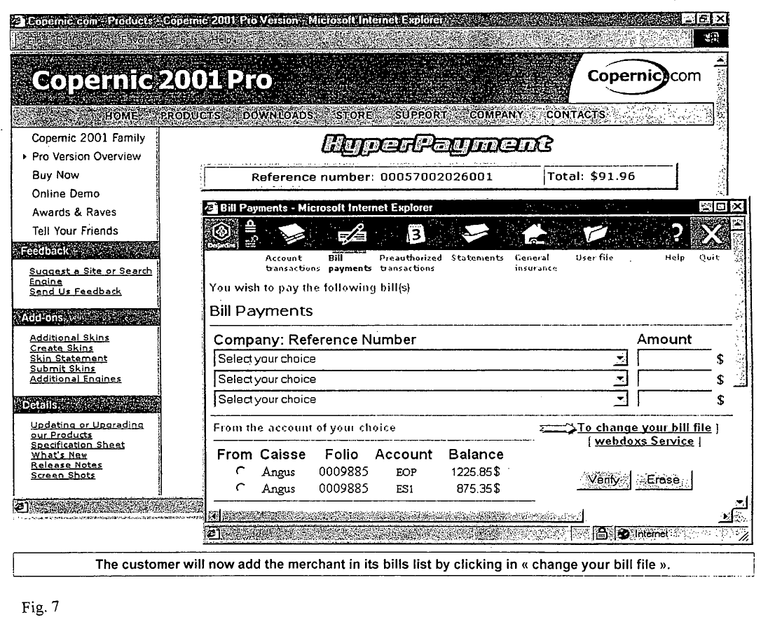

As shown in FIG. 7, once the payment of bill option has been selected, a screen will be provided providing choices of different bills to be paid.

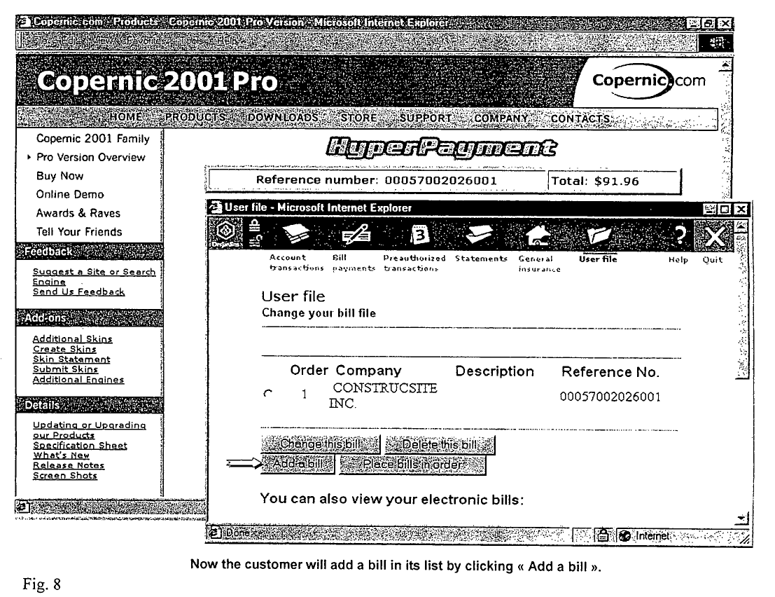

FIG. 8 shows a subsequent screen wherein one has various options including those to modify a bill or add a bill thereto.

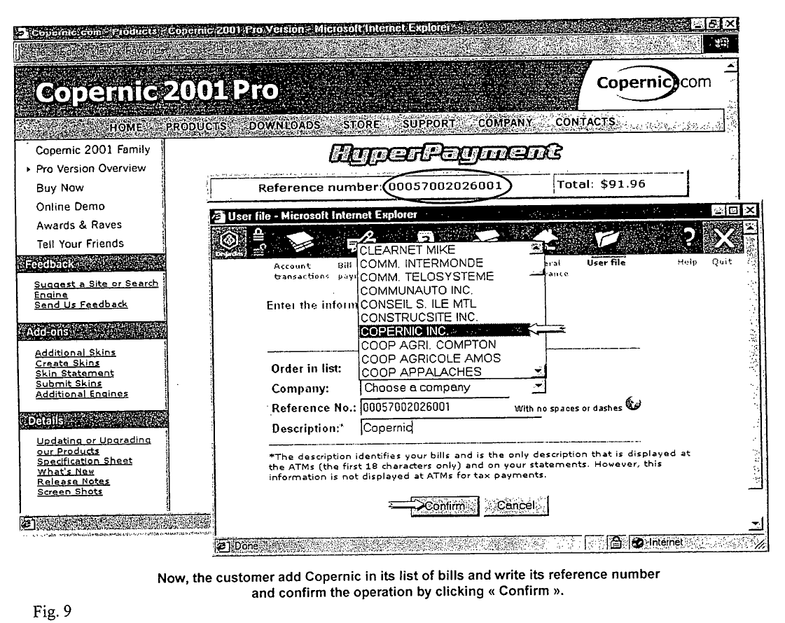

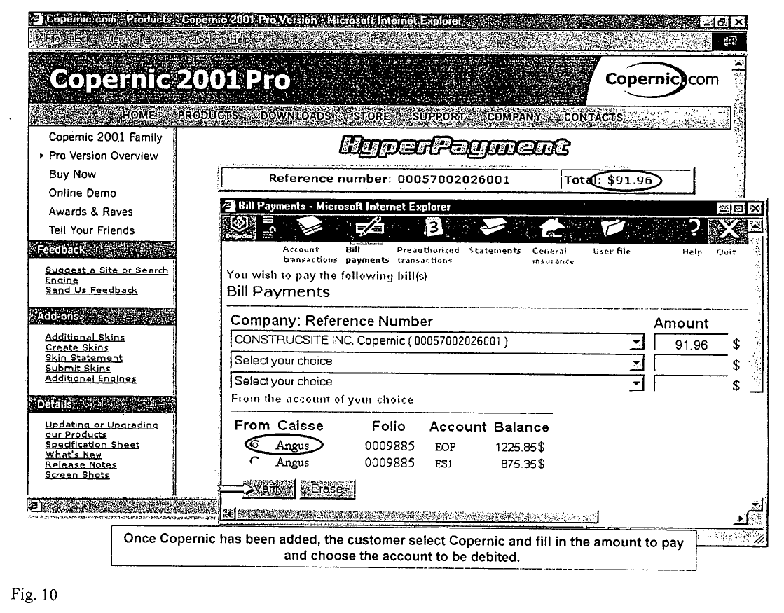

In FIG. 9, there is shown a pull down menu wherein one can select the merchant to be paid while FIG. 10 shows a subsequent screen permitting selection of a particular account which is to be debited.

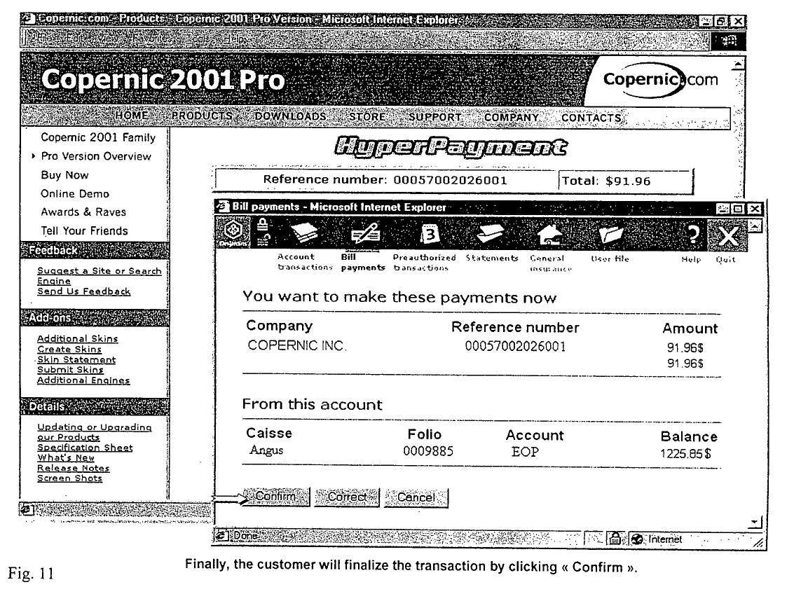

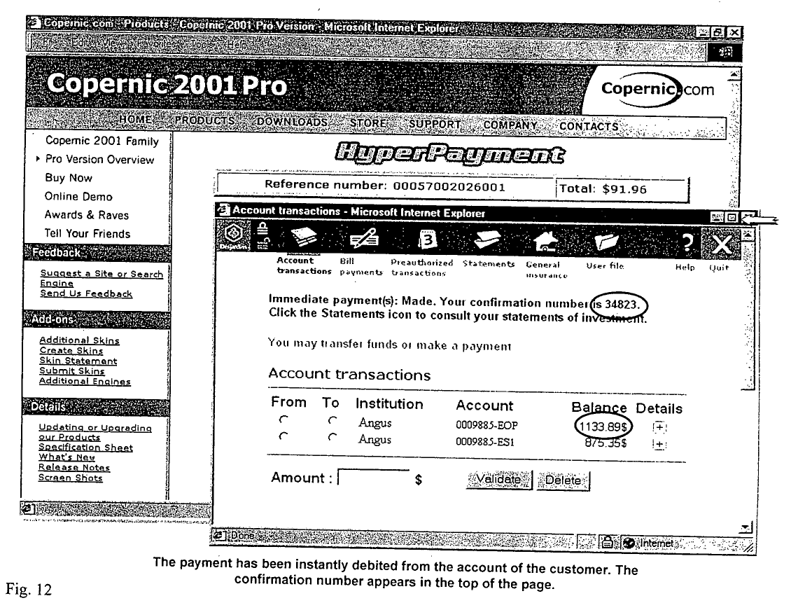

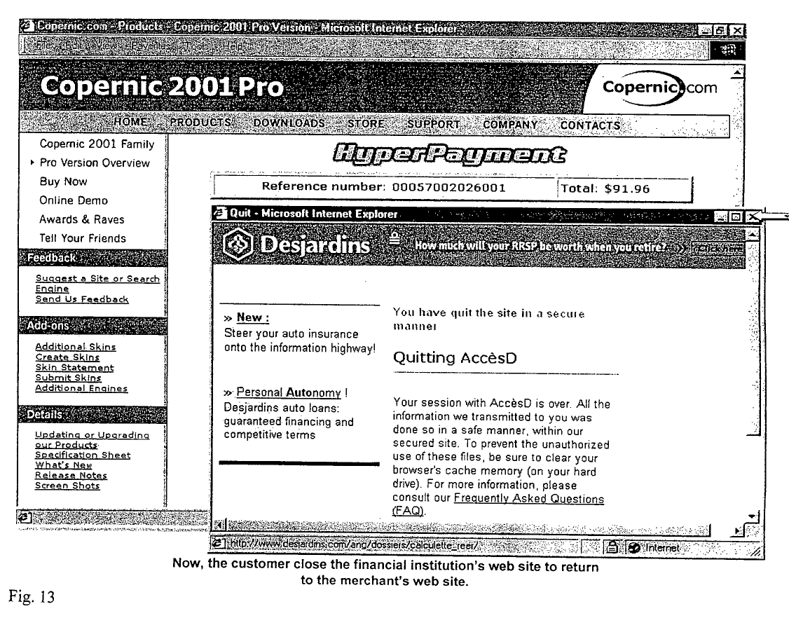

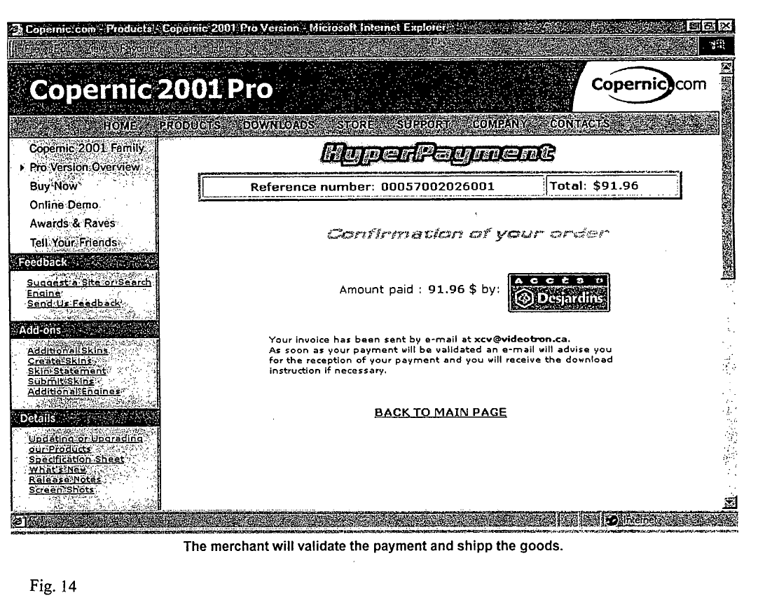

FIG. 11 show a subsequent screen from the financial institution wherein one has the option of confirming, correcting, or canceling the particular payment. Subsequently, as shown in FIG. 12, a screen provides a confirmation number for the transaction which has now been completed. As shown in FIGS. 13 and 14, subsequent screens provide for exit from the site of the financial institution and return to the main web page.

As will be seen from the above, there is provided a simple method for the completion of the financial transaction while maintaining a high level of security and not providing the financial information to the merchant.

Naturally various modifications may be made to the above described embodiment. Thus, while the illustrated embodiment shows the completion on the merchant's web site, this could also be conducted on a remote web page. While the hyperlink with the financial institution is shown in the illustrated embodiment, various options may be employed including sending the link with the invoice in the e-mail of the customer who would then go to the financial institution and pay the invoice. Similarly, various different means of confirmation of the payment to the merchant may be employed.

I claim:

1. A method for conducting a financial transaction over the Internet between a purchaser and a seller comprising the steps of:
receiving a request to purchase a good or service from a customer;
supplying the customer with an identifier;
linking a customer with a financial institution for authorizing payment for the good or service; and
making payment from the financial institution for the good and/or service.

2. The method of claim 1 wherein the step of linking a customer with a financial institution comprises the step of supplying a hyperlink.

3. The method of claim 2 wherein the step of linking a customer with a financial institution for authorizing payment for the good or service includes the further step of the financial institution providing confirmation that said payment has been authorized and made.
